(19) United States
(12) Patent Application Publication
(10) Pub. No.: US 2022/0398845 A1
(43) Pub. Date: Dec. 15, 2022

(54) METHOD AND DEVICE FOR SELECTING KEYFRAME BASED ON MOTION STATE

(71) Applicant: Beijing Moviebook Science and Technology Co., Ltd., Beijing (CN)

(72) Inventor: Chunbin LI, Beijing (CN)

(73) Assignee: Beijing Moviebook Science and Technology Co., Ltd., Beijing (CN)

(21) Appl. No.: 17/778,411

(22) PCT Filed: Nov. 19, 2020
(86) PCT No.: PCT/CN2020/130050

§ 371 Date: May 20, 2022

(30) Foreign Application Priority Data
Nov. 20, 2019 (CN) 201911142539.X

(51) Int. Cl. G06V 20/40; G06V 10/74

(52) U.S. Cl. CPC G06V 20/46; G06V 10/74; G06V 20/54

(57) ABSTRACT

A method for selecting a keyframe based on a motion state includes: sequentially storing several groups of adjacent images in a key frame sequence; extracting feature points from the images, and sequentially matching the feature point of an i^{th} image with the feature points of the subsequent images until the number of matched feature points reaches a preset threshold value, to form a new key frame sequence; calculating a fundamental matrix between adjacent frames in the new key frame sequence, decomposing the fundamental matrix into a rotation matrix and a translation vector aa, and decomposing the non-singular rotation matrix according to coordinate axis directions to obtain a deflection angle of each coordinate axis; and comparing the deflection angle with a predetermined threshold value, selecting a current frame having the deflection angle greater than the threshold value as a key frame, and adding same to a final key frame sequence.

### CROSS REFERENCE TO THE RELATED APPLICATIONS

This application is the national phase entry of International Application No. PCT/CN2020/130050, filed on Nov. 19, 2020, which is based upon and claims priority to Chinese Patent Application No. 201911142539.X, filed on Nov. 20, 2019, the entire contents of which are incorporated herein by reference.

### TECHNICAL FIELD

The present application relates to the field of traffic image processing, and in particular to a method and a device for selecting a keyframe based on a motion state.

### BACKGROUND

Real-time VO/VSLAM and large-scale structure from motion (SFM) pose severe challenges to limited computational resources. In order to overcome this problem and reduce data redundancy, some keyframes instead of all frames are selected from a sequence of images or a video to be processed generally, thereby greatly reducing computational pressure while ensuring accuracy and reliability. Further, an appropriate strategy for selecting a keyframe can improve the accuracy and consistency of local motion estimation by using the VO/VSLAM. Therefore, how to select the keyframes is an important factor to improve the accuracy and real-time performance of the visual SLAM (simultaneous localization and mapping) algorithm.

Currently, a keyframe is selected in the following manners. In a manner a, the keyframe is selected at equal intervals or equal distances. Parallel tracking and mapping (PTAM) has to meet a preset tracking condition when inserting a keyframe, that is, a distance from a previous keyframe meets a preset translation and rotation angle. A manner b for selection of keyframe based on image overlap. The keyframe is generated based on nonlinear optimized visual-inertial SLAM (OKVIS) when a matching point in an overlapping area is less than 50% of a detected point. Further, a furthest keyframe is marginalized, and a newest set of frames and another set of keyframes are reserved. A manner c for selection of keyframe based on parallax. If average parallax of tracked features exceeds a certain threshold, the current frame is determined as a keyframe. A manner d for selection of keyframe based on an image content index. A feature clustering space of a current frame is established, then a feature distance between the current frame and a next frame is calculated, and a keyframe are selected based on a feature distance threshold.

The selection of keyframe at equal intervals is easy to implement and does not involves additional calculation, but is not flexible enough. Other manners (such as image overlap, parallax) have better performance, whereas a feature may be extracted and matched repeatedly, and calculation of parallax and covariance is time-consuming, resulting in a reduction in real-time performance.

### SUMMARY

The present application aims to overcome the above problems or at least partially solve or alleviate the above problems.

A method for selecting a keyframe based on a motion state is provided according to an aspect of the present application. The method includes:

an initialization step of: storing multiple successive groups of images into a keyframe sequence F sequentially, where each group of images includes two successive frames; and preprocessing the images, where the images in the keyframe sequence F are f₁ to fₙ sequentially;

a feature point matching step of: extracting a feature point from an image in the keyframe sequence F, and matching a feature point of the image fᵢ with a feature point of an image fᵢ₊ₖ; setting k=k+1 and matching the feature point of the image fᵢ with a feature point of an image fᵢ₊ₖ in a case that the number of matched feature points is less than a preset threshold, until the number of matched feature points reaches the preset threshold, to obtain a feature point pair between images, where i is initially equal to 3, k is the number of frames between images and is initially equal to 1; a decomposition step of: calculating a fundamental matrix E between successive frames in the keyframe sequence F based on the obtained feature point pair, and decomposing the fundamental matrix E into a rotation matrix R and a translation vector T̆; recalculating a fundamental matrix E in a case that the rotation matrix R is a singular matrix or a translation scale of the translation vector exceeds a preset threshold, until the rotation matrix R is a non-singular matrix and the translation scale of the translation vector does not exceed the preset threshold;

an angle of deflection calculation step of: decomposing the rotation matrix R that is a non-singular matrix according to a direction of a coordinate axis, to obtain an angle of deflection of each coordinate axis; and a keyframe selection step of: selecting a current frame as a keyframe and adding the selected frame to the final keyframe sequence in a case that each angle of deflection satisfies a threshold condition; setting k=k+1 and proceeding to the feature point matching step if at least one angle of deflection does not satisfy the threshold condition; and setting k=1 and i=i+1 and proceeding to the feature point matching step if at least one angle of deflection does not satisfy the threshold condition in a case of k=m.

Optionally, the threshold condition in the keyframe selection step is: α<mα∥β<mβ∥γ<mγ, and α, β, and γ are angles of deflection of the Euler angles in X-axis, Y-axis, and Z-axis directions, respectively.

Optionally, in the decomposition step, the fundamental matrix E is calculated by using a five-point method and a RANSAC algorithm.

Optionally, in the feature point matching step, the feature point is extracted by using a FAST method.

Optionally, a dataset used in the method is a KITTI dataset.

A device for selecting a keyframe based on a motion state is provided according to an aspect of the present application. The device includes: an initialization module, a feature point matching module, a decomposition module, an angle of deflection calculation module, and a keyframe selection module.

The initialization module is configured to store a plurality of successive groups of images into a keyframe sequence F sequentially, where each group of images includes two successive frames; and preprocessing the images. The images in the keyframe sequence F are f₁ to fₙ sequentially.

The feature point matching module is configured to extract a feature point from an image in the keyframe sequence F, and match a feature point of the image fᵢ with a feature point of an image fᵢ₊ₖ; set k=k+1 and match the feature point of the image fᵢ with a feature point of an image fᵢ₊ₖ in a case that the number of matched feature points is less than a preset threshold, until the number of matched feature points reaches the preset threshold, to obtain a feature point pair between images. i is initially equal to 3, k is the number of frames between images and is initially equal to 1.

The decomposition module is configured to calculate a fundamental matrix E between successive frames in the keyframe sequence F based on the obtained feature point pair, and decompose the fundamental matrix E into a rotation matrix R and a translation vector T̆; recalculate a fundamental matrix E in a case that the rotation matrix R is a singular matrix or a translation scale of the translation vector exceeds a preset threshold, until the rotation matrix R is a non-singular matrix and the translation scale of the translation vector does not exceed the preset threshold.

The angle of deflection calculation module is configured to decompose the rotation matrix R that is a non-singular matrix according to a direction of a coordinate axis, to obtain an angle of deflection of each coordinate axis.

The keyframe selection module is configured to select a current frame as a keyframe and add the selected frame to the final keyframe sequence in a case that each angle of deflection satisfies a threshold condition; set k=k+1 and proceed to the feature point matching step if at least one angle of deflection does not satisfy the threshold condition; and set k=1 and i=i+1 and proceed to the feature point matching step if at least one angle of deflection does not satisfy the threshold condition in a case of k=m.

Optionally, the threshold condition in the keyframe selection module is: α<mα∥β<mβ∥γ<mγ, and α, β, and γ are angles of deflection of the Euler angles in X-axis, Y-axis, and Z-axis directions, respectively.

Optionally, in the decomposition module, the fundamental matrix E is calculated by using a five-point method and a RANSAC algorithm.

Optionally, in the feature point matching module, the feature point is extracted by using a FAST method.

Optionally, a dataset used by the device is a KITTI dataset.

With the method and the device for selecting a keyframe based on a motion state according to the present application, the motion state of an object is predicted based on a change in an pose between frames within a certain time interval, and then the keyframe is selected, thereby balancing flexibility and real-time performance of the keyframe. In addition, influence of a corner tracking threshold and an object motion offset angle on the keyframe is further evaluated with the method and the device.

The above and other objects, advantages and features of the present application will be more apparent to those skilled in the art from the following detailed description of the embodiments of the present application in conjunction with the drawings.

### BRIEF DESCRIPTION OF THE DRAWINGS

Hereinafter, some embodiments of the present application are described in detail by way of example and not limitation with reference to the drawings. The same reference numbers in the drawings designate the same or similar components or parts. It should be understood by those skilled in the art that the drawings are not necessarily to scale. In the drawings:

FIG. 1 is a schematic flowchart illustrating a method for selecting a keyframe based on a motion state according to an embodiment of the present application;

FIG. 2 is a schematic structural block diagram illustrating a device for selecting a keyframe based on a motion state according to an embodiment of the present application;

FIG. 3 is a schematic structural block diagram illustrating a computing device according to an embodiment of the present application; and

FIG. 4 is a schematic structural block diagram illustrating a computer-readable storage medium according to an embodiment of the present application.

### DETAILED DESCRIPTION OF THE EMBODIMENTS

A method for selecting a keyframe based on a motion state is provided according to an embodiment of the present application. An experimental dataset used in the method is the KITTI dataset (co-founded by Karlsruhe Institute of Technology in Germany and Toyota Technological Institute in American). This dataset is currently the largest computer vision algorithm evaluation dataset in the world for autonomous driving scenarios. An acquisition platform for KITTI data includes 2 grayscale cameras, 2 color cameras, a Velodyne 3D lidar, 4 optical lenses, and a GPS navigation system. The entire dataset consists of 389 pairs of stereo images and optical flow maps (where each image contains up to 15 vehicles and 30 pedestrians with varying degrees of occlusion), a visual ranging sequence of 39.2 kilometers, and more than 200,000 images of 3D annotated objects.

The change in a pose of a vehicle includes: a, a change in a yaw angle around the Y axis when the vehicle travels along a horizontal plane; b, a change in a pitch angle around the X axis when the vehicle travels uphill and downhill; c, a change in a roll angle around the Z axis in case of lateral jitter. A local motion of a camera remains unchanged within a short time interval, and then the keyframe is selected based on a change in a pose angle.

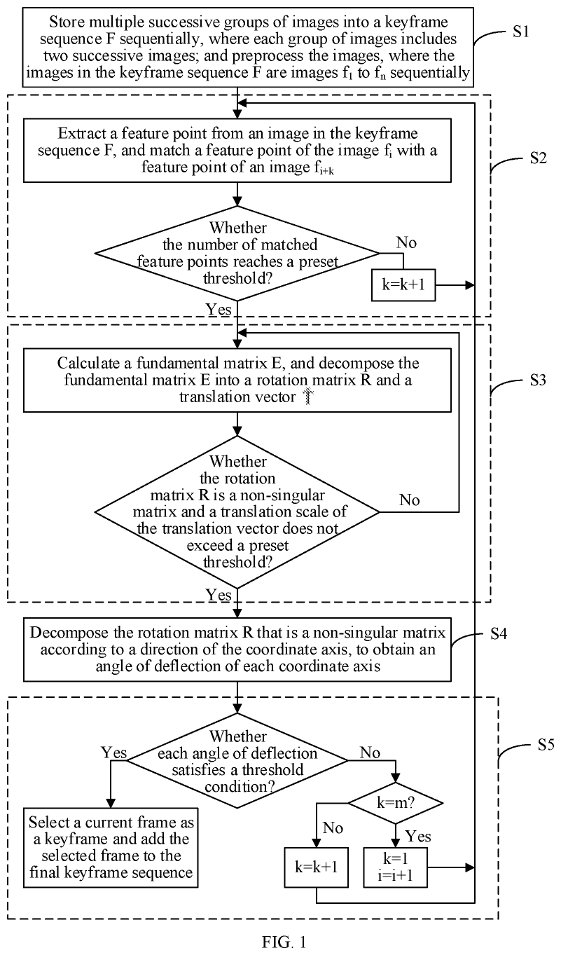

FIG. 1 is a schematic flowchart illustrating a method for selecting a keyframe based on a motion state according to an embodiment of the present application. The method generally includes the following steps S1 to S5.

In an initialization step S1, serialized images fᵢ, f₂, . . . fₙ are read.

In the initialization process, a first frame image and a second frame image are stored in F, and a next frame is tracked. If tracking of the next frame fails, two successive frames are selected and stored in F, and so on.

In a feature point matching step S2, a feature point in an image fᵢ (where an initial value of i is 3) is detected using the FAST method, and then a feature point in an image fᵢ₊ₖ (where an initial value of k is 1) is tracked. That is, the feature point in the image fᵢ is matched with the feature point in the image fᵢ₊ₖ. In a case that the number of matched feature points is less than a preset threshold, a feature point in the image fᵢ is detected one more time, and the feature point in the image fᵢ is matched with the feature point in the image fᵢ₊ₖ. In a case that the number of matched feature points is less than the preset threshold one more time, the image fᵢ₊ₖ is ignored, and the interval is increased, that is, k=k+1, and then the feature point in the image fᵢ is matched with a feature point in another image fᵢ₊ₖ, and so on. The value of k is increasing until the number of matched feature points between the image fᵢ and an image f_{q} reaches the threshold, and then a feature point pair between the image fᵢ and the image f_{q} is obtained.

In a decomposition step S3, a fundamental matrix E is calculated based on the obtained feature point pair between the image fᵢ and the image f_{q} by using the five-point method and the RANSAC algorithm, and the fundamental matrix E is decomposed into a rotation matrix R and a translation vector T̆.

It is assumed that coordinate spaces of two images are P={p1, p2, . . . , pn}, Q={q1, q2, . . . , qn}, which are expressed as Q=RP+t by an external rotation element (Rt) after rotation and translation, where

$$R = [ \begin{matrix}{r}_{00} & {r}_{01} & {r}_{02} \\ {r}_{10} & {r}_{11} & {r}_{12} \\ {r}_{20} & {r}_{21} & {r}_{22}\end{matrix} ] , R * {R}^{T} = I , det ( R ) = 1$$

The matrix R here is called the rotation matrix, also known as the direction cosine matrix (DCM). In a case that R is a singular matrix, or a translation scale of the translation vector exceeds a preset threshold, the fundamental matrix E is recalculated until the rotation matrix R is a non-singular matrix and the translation scale of the translation vector does not exceed the preset threshold.

In an angle of deflection calculation step S4, components of the Euler angles in directions of the three coordinate axes X, Y, and Z are calculated. The calculated three components are a pitch angle α, a heading angle β, and a roll angle γ. The matrix R is calculated as follows:

$$R ( α , β , γ ) = {R}_{z} ( γ ) {R}_{y} ( β ) {R}_{x} ( α ) = [ \begin{matrix}{c}_{β} {c}_{γ} & {s}_{α} {s}_{β} {c}_{γ} - {c}_{α} {s}_{γ} & {s}_{α} {s}_{γ} + {c}_{α} {s}_{β} {c}_{γ} \\ {c}_{β} {s}_{γ} & {c}_{α} {c}_{γ} + {s}_{α} {s}_{β} {s}_{γ} & {c}_{α} {s}_{β} {s}_{γ} - {s}_{α} {c}_{γ} \\ - {s}_{β} & {s}_{α} {c}_{β} & {c}_{α} {c}_{β}\end{matrix} ]$$

where R_{z}(γ) represents a rotation angle around the Z axis, R_{y}(β) represents a rotation angle around the Y axis, Rₓ(α) represents a rotation angle around the X axis, c_{α}, c_{β}, c_{γ} are abbreviations for cos α, cos β, cos γ, respectively; s_{α}, s_{β}, and s_{γ} are abbreviations for sin α, sin β, and sin γ, respectively.

Then an attitude angle is obtained as follows.

(1) In a case that |r₂₀|<1−ξ, the attitude angle is expressed as follows:

$$\{ \begin{matrix}α = arctan ( {r}_{21} , {r}_{22} ) \\ β = arcsin ( - {r}_{20} ) \\ γ = arctan ( {r}_{10} , {r}_{00} )\end{matrix}$$

where ξ is a preset small positive number, such as 10⁻¹⁰.

(2) In a case that r₂₀>1−ξ and β→π/2, an approximation is set as cos(β)≈0 and sin(β)≈1, and then the attitude angle is approximately expressed as:

$$\{ \begin{matrix}β = arcsin ( - {r}_{20} ) \\ α - γ = arctan ( - {r}_{12} , {r}_{11} )\end{matrix}$$

(3) In a case that r₂₀<1−ξ and β→−π/2, an approximation is set as cos(β)≈0 and sin(β)≈−1, and then the attitude angle is approximately expressed as:

$$\{ \begin{matrix}β = arcsin ( - {r}_{20} ) \\ α + γ = arctan ( - {r}_{12} , {r}_{11} )\end{matrix}$$

In a keyframe selection step S5, in a case of α<mα∥β<mβ∥γ<mγ, a current frame is inserted into the final keyframe sequence F. m is a maximum value of the preset number of frame intervals. mα, mβ and my are three preset attitude angle thresholds. In a case that the obtained three angles of deflection α, β, and γ do not satisfy α<mα∥β<mβ∥γ<mγ, k is set to 1 and i is set to i+1, and then the method returns to step S2.

In the above method for selecting a keyframe based on a motion state, the large-scale motion in a direction other than a forward direction is ignored. The constraint of a slight motion is alleviated by a corner tracking algorithm, consistency of feature points between discrete frames is evaluated, and a threshold and an interval step size for a change in a pose angle between frames are determined, ensuring that corner tracking is not lost and the motion state of the object is accurately restored, thereby balancing flexibility and real-time performance of keyframe.

A device for selecting a keyframe based on a motion state is further provided according to an embodiment of the present application. An experimental dataset used by the device is the KITTI dataset (co-founded by Karlsruhe Institute of Technology in Germany and Toyota Technological Institute in American). This dataset is currently the largest computer vision algorithm evaluation dataset in the world for autonomous driving scenarios. An acquisition platform for KITTI data includes 2 grayscale cameras, 2 color cameras, a Velodyne 3D lidar, 4 optical lenses, and a GPS navigation system. The entire dataset consists of 389 pairs of stereo images and optical flow maps (where each image contains up to 15 vehicles and 30 pedestrians with varying degrees of occlusion), a visual ranging sequence of 39.2 kilometers, and more than 200,000 images of 3D annotated objects.

The change in a pose of a vehicle includes: a, a change in a yaw angle around the Y axis when the vehicle travels along a horizontal plane; b, a change in a pitch angle around the X axis when the vehicle travels uphill and downhill; c, a change in a roll angle around the Z axis in case of lateral jitter. A local motion of a camera remains unchanged within a short time interval, and then the keyframe is selected based on a change in a pose angle.

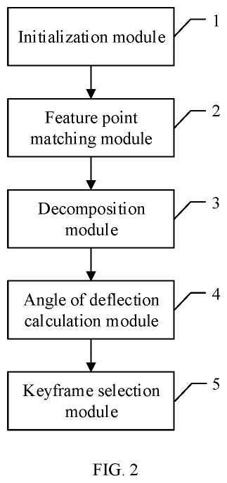

FIG. 2 is a schematic structural block diagram illustrating a device for selecting a keyframe based on a motion state according to an embodiment of the present application. The device generally includes an initialization module 1, a feature point matching module 2, a decomposition module 3, an angle of deflection calculation module 4, and a keyframe selection module 5.

The initialization module 1 is configured to read serialized images f₁, f₂, . . . , fa, and initialize a keyframe sequence F. In the initialization process, a first frame image and a second frame image are stored in F, and a next frame is tracked. If tracking of the next frame fails, two successive frames are selected and stored in F, and so on.

The feature point matching module 2 is configured to detect a feature point in an image fᵢ (where an initial value of i is 3) using the FAST method, and track a feature point in an image fᵢ₊ₖ (where an initial value of k is 1). That is, the feature point in the image fᵢ is matched with the feature point in the image fᵢ₊ₖ. In a case that the number of matched feature points is less than a preset threshold, a feature point in the image fᵢ is detected one more time, and the feature point in the image fᵢ is matched with the feature point in the image fᵢ₊ₖ. In a case that the number of matched feature points is less than the preset threshold one more time, the image fᵢ₊ₖ is ignored, and the interval is increased, that is, k=k+1, and then the feature point in the image fᵢ is matched with a feature point in another image fᵢ₊ₖ, and so on. The value of k is increasing until the number of matched feature points between the image fᵢ and an image f_{q} reaches the threshold, and then a feature point pair between the image fᵢ and the image f_{q} is obtained.

The decomposition module 3 is configured to calculate a fundamental matrix E based on the obtained feature point pair between the image fᵢ and the image f_{q} by using the five-point method and the RANSAC algorithm, and decompose the fundamental matrix E into a rotation matrix R and a translation vector T.

It is assumed that coordinate spaces of two images are P={p1, p2, . . . , pn}, Q={q1, q2, . . . , qn}, which are expressed as Q=RP+t by an external rotation element (RIO after rotation and translation, where

$$R = [ \begin{matrix}{r}_{00} & {r}_{01} & {r}_{02} \\ {r}_{10} & {r}_{11} & {r}_{12} \\ {r}_{20} & {r}_{21} & {r}_{22}\end{matrix} ] , R * {R}^{T} = I , det ( R ) = 1$$

The matrix R here is called the rotation matrix, also known as the direction cosine matrix (DCM). In a case that R is a singular matrix, or a translation scale of the translation vector exceeds a preset threshold, the fundamental matrix E is recalculated until the rotation matrix R is a non-singular matrix and the translation scale of the translation vector does not exceed the preset threshold.

The angle of deflection calculation module 4 is configured to calculate components of the Euler angles in directions of the three coordinate axes X, Y, and Z. The calculated three components are a pitch angle α, a heading angle β, and a roll angle γ. The matrix R is calculated as follows:

$$R ( α , β , γ ) = {R}_{z} ( γ ) {R}_{y} ( β ) {R}_{x} ( α ) = [ \begin{matrix}{c}_{β} {c}_{γ} & {s}_{α} {s}_{β} {c}_{γ} - {c}_{α} {s}_{γ} & {s}_{α} {s}_{γ} + {c}_{α} {s}_{β} {c}_{γ} \\ {c}_{β} {s}_{γ} & {c}_{α} {c}_{γ} + {s}_{α} {s}_{β} {s}_{γ} & {c}_{α} {s}_{β} {s}_{γ} - {s}_{α} {c}_{γ} \\ - {s}_{β} & {s}_{α} {c}_{β} & {c}_{α} {c}_{β}\end{matrix} ]$$

where R_{z}(γ) represents a rotation angle around the Z axis, R_{y}(β) represents a rotation angle around the Y axis, Rₓ(α) represents a rotation angle around the X axis, c_{α}, c_{β}, c_{γ} are abbreviations for cos α, cos β, cos γ, respectively; s_{α}, s_{β}, and s_{γ} are abbreviations for sin α, sin β, and sin γ, respectively.

Then an attitude angle is obtained as follows.

(1) In a case that r₂₀<1−ξ, the attitude angle is expressed as follows:

$$\{ \begin{matrix}α = arctan ( {r}_{21} , {r}_{22} ) \\ β = arcsin ( - {r}_{20} ) \\ γ = arctan ( {r}_{10} , {r}_{00} )\end{matrix}$$

where ξ is a preset small positive number, such as 10⁻¹⁰.

(2) In a case that r₂₀>1−ξ and β→π/2, an approximation is set as cos(β)≈0 and sin(β)≈1, and then the attitude angle is approximately expressed as:

$$\{ \begin{matrix}β = arcsin ( - {r}_{20} ) \\ α - γ = arctan ( - {r}_{12} , {r}_{11} )\end{matrix}$$

(3) In a case that r₂₀<1−ξ and β→−π/2, an approximation is set as cos(β)≈0 and sin(β)≈−1, and then the attitude angle is approximately expressed as:

$$\{ \begin{matrix}β = arcsin ( - {r}_{20} ) \\ α + γ = arctan ( - {r}_{12} , {r}_{11} )\end{matrix}$$

The keyframe selection module 5 is configured to insert, in a case of α<mα∥β<mβ∥γ<mγ, a current frame into the final keyframe sequence F. m is a maximum value of the preset number of frame intervals. mα, mβ and my are three preset attitude angle thresholds. In a case that the obtained three angles of deflection α, β and γ do not satisfy α<mα∥β<mβ∥γ<mγ, k is set to 1 and i is set to i+1, and then the feature point matching module 2 starts operating.

With the above device for selecting a keyframe based on a motion state, the large-scale motion in a direction other than a forward direction is ignored. The constraint of a slight motion is alleviated by a corner tracking algorithm, consistency of feature points between discrete frames is evaluated, and a threshold and an interval step size for a change in a pose angle between frames are determined, ensuring that corner tracking is not lost and the motion state of the object is accurately restored, thereby balancing flexibility and real-time performance of keyframe.

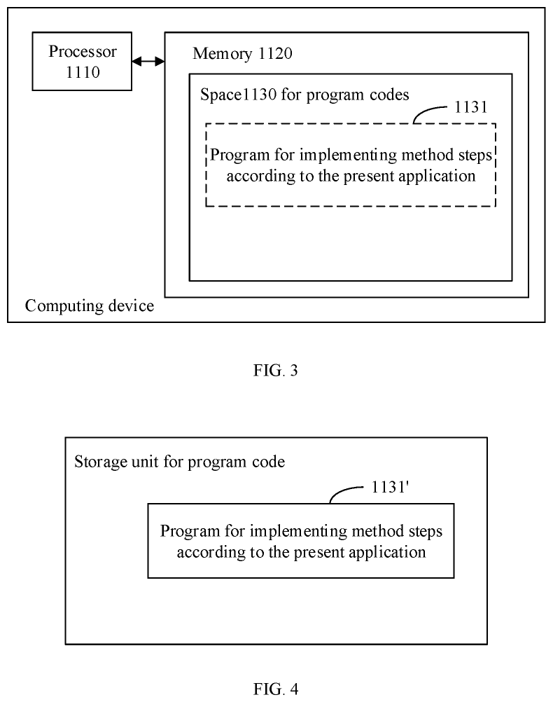

A computing device is further provided according to an embodiment of the present application. Referring to FIG. 3, the computing device includes a memory 1120, a processor 1110, and a computer program stored in the memory 1120 and executable by the processor 1110. The computer program is stored in space 1130 for program codes in the memory 1120. The computer program, when executed by the processor 1110, implements any one of the method steps 1131 according to the present application.

A computer-readable storage medium is further provided according to an embodiment of the present application. Referring to FIG. 4, the computer-readable storage medium includes a storage unit for program codes. The memory unit is provided with a program 1131′ for implementing the method steps according to the present application. The program is executed by the processor.

A computer program product including instructions is further provided according to the embodiments of the present application. The computer program product, when run on a computer, causes the computer to perform the method steps according to the present application.

In the foregoing embodiments, implementation may be entirely or partially performed by using software, hardware, firmware or any combination thereof. When the embodiments are implemented by using software, all or some of the embodiments may be implemented in a form of a computer program product. The computer program product includes one or more computer instructions. When the computer program instructions are loaded and executed in a computer, all or some of the processes or functions according to the embodiments of the present application are implemented. The computer may be a general-purpose computer, a special-purpose computer, a computer network, or another programmable apparatus. The computer instructions may be stored in a computer readable storage medium or may be transmitted from a computer readable storage medium to another computer readable storage medium. For example, the computer instructions may be transmitted from a website, a computer, server, or a data center to another website, computer, server, or data center in a wired (for example, a coaxial cable, an optical fiber, or a digital subscriber line (DSL)) or wireless (for example, infrared, radio, or microwave) manner. The computer readable storage medium may be any available medium capable of being accessed by a computer or may be a data storage device including one or more available medium, such as a server and a data center. The available medium may be a magnetic medium (for example, a floppy disk, a hard disk, or a magnetic tape), an optical medium (for example, a DVD), a semiconductor medium (for example, a solid-state disk (SSD)), or the like.

Those skilled in the art should further understand that the units and algorithm steps described in examples in combination with the embodiments according to the present application may be implemented by electronic hardware, computer software, or a combination of electronic hardware and computer software. In order to clearly illustrate the interchangeability of hardware and software, details and steps in each example are described in terms of functions in the above description. Whether the functions being implemented by the hardware or by the software depends on applications of the technical solution and design constraint conditions. Those skilled in the art may use different methods to implement the described functions for each particular application, and such implementation should not be regarded as going beyond the scope of the present application.

Those skilled in the art should understand that all or part of the steps in the method according to the above embodiments may be completed by instructing a processor through a program. The described program may be stored in a computer-readable storage medium. The storage medium is a non-transitory medium such as a random-access memory, a read only memory, a flash memory, a hard disk, a solid-state disk, a magnetic tape, a floppy disk, an optical disc, and any combination thereof.

Only preferred embodiments of the present application are illustrated above. However, the protection scope of the present application is not limited thereto. Any changes or substitutions that may be easily conceived by those skilled in the art within the technical scope disclosed in the present application shall be covered by the protection scope of the present application. Therefore, the protection scope of the present application should be subject to the protection scope of the claims.

What is claimed is:

1. A method for selecting a keyframe based on a motion state, comprising:
an initialization step of: storing a plurality of successive groups of images into a keyframe sequence F sequentially, wherein each of the plurality of successive groups of images comprises two successive frames; and preprocessing the images, wherein the images in the keyframe sequence F are f₁ to fₙ sequentially;
a feature point matching step of: extracting a feature point from an image in the keyframe sequence F, and matching a feature point of an image fᵢ with a feature point of an image fᵢ₊ₖ; setting k=k+1 and matching the feature point of the image fᵢ with a feature point of an image fᵢ₊ₖ in a case that a number of matched feature points is less than a first preset threshold, until the number of matched feature points reaches the first preset threshold, to obtain a feature point pair between images, wherein i is initially equal to 3, k is a number of frames between images and is initially equal to 1;
a decomposition step of: calculating a fundamental matrix E between successive frames in the keyframe sequence F based on the feature point pair, and decomposing the fundamental matrix E into a rotation matrix R and a translation vector T̆; recalculating the fundamental matrix E in a case that the rotation matrix R is a singular matrix or a translation scale of the translation vector exceeds a second preset threshold, until the rotation matrix R is a non-singular matrix and the translation scale of the translation vector does not exceed the second preset threshold;
an angle of deflection calculation step of: decomposing the rotation matrix R that is a non-singular matrix according to a direction of a coordinate axis, to obtain an angle of deflection of each coordinate axis; and
a keyframe selection step of: selecting a current frame as a keyframe and adding the current frame to a final keyframe sequence in a case that each angle of deflection satisfies a threshold condition; setting k=k+1 and proceeding to the feature point matching step when at least one angle of deflection does not satisfy the threshold condition; and setting k=1 and i=i+1 and proceeding to the feature point matching step when at least one angle of deflection does not satisfy the threshold condition in a case of k=m.

2. The method according to claim 1, wherein the threshold condition in the keyframe selection step is: α<mα∥β<mβ∥γ<mγ, and α, β, and γ are angles of deflection of Euler angles in X-axis, Y-axis, and Z-axis directions, respectively.

3. The method according to claim 1, wherein in the decomposition step, the fundamental matrix E is calculated by using a five-point method and a RANSAC algorithm.

4. The method according to claim 1, wherein in the feature point matching step, the feature point is extracted by using a FAST method.

5. The method according to claim 1, wherein a dataset used in the method is a KITTI dataset.

6. A device for selecting a keyframe based on a motion state, comprising:
an initialization module configured to store a plurality of successive groups of images into a keyframe sequence F sequentially, wherein each of the plurality of successive groups of images comprises two successive frames; and preprocess the images, wherein the images in the keyframe sequence F are f₁ to fₙ sequentially;
a feature point matching module configured to extract a feature point from an image in the keyframe sequence F, and match a feature point of an image fᵢ with a feature point of an image fᵢ₊ₖ; set k=k+1 and match the feature point of the image fᵢ with a feature point of an image fᵢ₊ₖ in a case that a number of matched feature points is less than a first preset threshold, until the number of matched feature points reaches the first preset threshold, to obtain a feature point pair between images, wherein i is initially equal to 3, k is a number of frames between images and is initially equal to 1;
a decomposition module configured to calculate a fundamental matrix E between successive frames in the keyframe sequence F based on the feature point pair, and decompose the fundamental matrix E into a rotation matrix R and a translation vector T̆; recalculate the fundamental matrix E in a case that the rotation matrix R is a singular matrix or a translation scale of the translation vector exceeds a second preset threshold, until the rotation matrix R is a non-singular matrix and the translation scale of the translation vector does not exceed the second preset threshold;
an angle of deflection calculation module configured to decompose the rotation matrix R that is a non-singular matrix according to a direction of a coordinate axis, to obtain an angle of deflection of each coordinate axis; and
a keyframe selection module configured to select a current frame as a keyframe and add the current frame to a final keyframe sequence in a case that each angle of deflection satisfies a threshold condition; set k=k+1 and proceed to the feature point matching step when at least one angle of deflection does not satisfy the threshold condition; and set k=1 and i=i+1 and proceed to the feature point matching step when at least one angle of deflection does not satisfy the threshold condition in a case of k=m.

7. The device according to claim 6, wherein the threshold condition in the keyframe selection module is: α<mα∥β<mβ∥γ<mγ, and α, β, and γ are angles of deflection of Euler angles in X-axis, Y-axis, and Z-axis directions, respectively.

8. The device according to claim 6, wherein in the decomposition module, the fundamental matrix E is calculated by using a five-point method and a RANSAC algorithm.

9. The device according to claim 6, wherein in the feature point matching module, the feature point is extracted by using a FAST method.

10. The device according to claim 6, wherein a dataset used by the device is a KITTI dataset.

11. The method according to claim 2, wherein in the decomposition step, the fundamental matrix E is calculated by using a five-point method and a RANSAC algorithm.

12. The method according to claim 2, wherein in the feature point matching step, the feature point is extracted by using a FAST method.

13. The method according to claim 3, wherein in the feature point matching step, the feature point is extracted by using a FAST method.

14. The method according to claim 2, wherein a dataset used in the method is a KITTI dataset.

15. The method according to claim 3, wherein a dataset used in the method is a KITTI dataset.

16. The method according to claim 4, wherein a dataset used in the method is a KITTI dataset.

17. The device according to claim 7, wherein in the decomposition module, the fundamental matrix E is calculated by using a five-point method and a RANSAC algorithm.

18. The device according to claim 7, wherein in the feature point matching module, the feature point is extracted by using a FAST method.

19. The device according to claim 8, wherein in the feature point matching module, the feature point is extracted by using a FAST method.

20. The device according to claim 7, wherein a dataset used by the device is a KITTI dataset.
